(19) United States
(12) Patent Application Publication
(10) Pub. No.: US 2015/0112534 A1
(43) Pub. Date: Apr. 23, 2015

(54) DATA PROCESSING DEVICE OF ELECTRIC VEHICLE

(71) Applicant: LSIS CO., LTD., Anyang-si (KR)

(72) Inventor: Ju Ho LIM, Ansan-si (KR)

(73) Assignee: LSIS CO., LTD., Anyang-si (KR)

(21) Appl. No.: 14/506,363

(22) Filed: Oct. 3, 2014

(30) Foreign Application Priority Data
Oct. 17, 2013 (KR) 10-2013-0124254

(51) Int. Cl. B60W 20/00; B60W 10/08; B60W 10/06

(52) U.S. Cl. CPC B60W 20/00; B60W 10/06; B60W 10/08
USPC 701/22

(57) ABSTRACT

A device for processing data generated and processed in an electric vehicle is provided. The electric vehicle includes an engine, a motor connected to the engine and generating a driving torque, and an electronic control unit (ECU) controlling an operation of the engine, detecting a driving request signal, and including a plurality of controller for processing data generated on the basis of the driving request signal, wherein the ECU allows each of the plurality of control units to process the data on the basis of information on the data.

### CROSS-REFERENCE TO RELATED APPLICATIONS

Pursuant to 35 U.S.C. §119(a), this application claims the benefit of earlier filing date and right of priority to Korean Patent Application No. 10-2013-0124254, filed on Oct. 17, 2013, the contents of which are hereby incorporated by reference herein in its entirety.

### BACKGROUND

The present invention relates to a device for processing data generated and processed in an electric vehicle.

An electric vehicle, which is one of future vehicles, may be driven by charging a secondary battery therein with a power supply plug connected to the vehicle in a general home and using the charged electric energy.

The electric vehicle includes an electronic control unit (ECU) for collecting sensing data sensed from various sensors inside the electric vehicle and controlling so as to process and store the collected data. The ECU is a control device for controlling various states of a vehicle engine and an automatic transmission, etc., and an amount of processing target data thereof is massive.

In addition, for the ECU, a processing speed thereof is very important since operation data and generation data according to the driving of the vehicle are required to be rapidly and accurately processed.

Although an ECU for a typical vehicle is released in a form of multiple cores being mounted thereon, the number of the cores may be less than 10. As the processing target data becomes massive according to intellectualization of the electric vehicle, a typical data processing and operation that is limited to a stereotyped data processing device may be restrictive. In other words, parallel processing and operation for a great amount of data using the limited control device may cause lowering of an operation speed and overloads. In addition, as electronic components requiring high performance are additionally mounted in the vehicle, processing with a typical ECU has a limit.

### SUMMARY

Embodiments provide a data processing device and method of an electric vehicle allowing data generated and processed in the vehicle requiring high performance to be rapidly and accurately processed.

In one embodiment, an electric vehicle includes an engine; a motor connected to the engine and generating a driving torque; and an electronic control unit (ECU) controlling an operation of the engine, detecting a driving request signal, and including a plurality of controller for processing data generated on the basis of the driving request signal, wherein the ECU allows each of the plurality of control units to process the data on the basis of information on the data.

The details of one or more embodiments are set forth in the accompanying drawings and the description below. Other features will be apparent from the description and drawings, and from the claims.

### BRIEF DESCRIPTION OF THE DRAWINGS

FIG. 1 is a block configuration diagram of an electric vehicle to which an embodiment is applied.

FIG. 2 is a block configuration diagram of an ECU according to an embodiment.

FIG. 3 is a flowchart of a data processing operation according to an embodiment.

FIG. 4 is a flowchart of a data processing operation according to another embodiment.

### DETAILED DESCRIPTION OF THE EMBODIMENTS

Terms and words used herein should not be construed limitedly by the common and dictionary meanings, but should be interpreted by meaning and concepts conforming to the technical idea of this invention based on the principle that the concept of terms and words can be defined properly by the inventor in order to describe this invention in the best ways . . . .

Therefore, it should be understood that since the configurations of the embodiments and drawings described herein are merely exemplary embodiments of the present invention, but do not include all the technical spirits of the present invention, there may be provided various equivalents and modifications which can be substituted for the above configurations

Reference will now be made in detail to the embodiments of the present disclosure, examples of which are illustrated in the accompanying drawings.

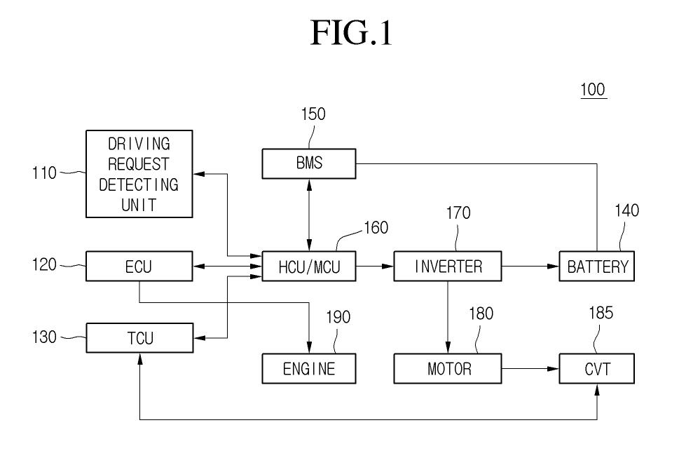

FIG. 1 is a block configuration diagram of an electric vehicle to which an embodiment is applied.

Referring to FIG. 1, an electric vehicle 100 to which an embodiment is applied may include a driving request detecting unit 110, an electronic control unit (ECU), a transmission control unit 130, a battery 140, an energy management system (EMS) 150, a hybrid control unit (HCU)/motor control unit (MCU) 160, an inverter 170, a motor 180, a continuously variable transmission (CVT) 185, and an engine 190.

The driving request detecting unit 100 may detect a request for driving a vehicle by a user. The driving request detecting unit 100 may detect an accelerator position sensor signal for start and acceleration requests, a brake pedal signal for a brake control, and an inhibitor switch signal for gear selection etc., and output electric information thereon.

The ECU 120 may control an overall operation of the engine 190 according to the vehicle driving request signal by the user and engine state information such as a coolant temperature and an engine's torque from the driving request detecting unit 110. In particular, the ECU 120 according to an embodiment may operate and process data generated according to driving and various sensors inside the vehicle.

The TCU 130 may detect various information data such as a current vehicle speed, a gear ratio and a clutch state and control an overall operation for an output torque control of the CVT 185.

The battery 140 may provide power to the motor 180 to support output power of the motor 180, and provide a voltage at the time of starting the engine by the motor 180. The battery 140 may be charged by recovering regenerative braking energy of the motor operating as a generator in an engine mode and at the time of braking control, or by using energy applied from a separate voltage supplier (through a power supply plug etc.)

The BMS 150 may detect information such as a voltage, current, or temperature of the battery 140, and manage and control a state of charge (SOC) of the battery 140. In addition, the EMS 150 may also control a current amount output at the time when power is support by the motor 180 or at the start of the engine 190.

The HCU/MCU 160 may integrate and control each controller according to a launch control request by the user and control the output torque and speed of the motor 180.

The inverter 170 is configured with an insulated gate bipolar transistor (IGBT) switching element, and may drive the motor 180 by converting a DC voltage from the battery 140 into a three phase AC voltage according to a pulse width modulation (PWM) control signal applied from the HCU/MCU 160.

The motor generator 180 may be driven by the voltage from the battery 140 and support power at the time of running by the output of the engine 190.

The CVT 185 may allow the vehicle to be driven by adjusting power transferred through the motor 180 with a transmission gear ratio adjusted according to a control by the TCU 130.

The engine 190 may have an output thereof controlled according to a control by the ECU 120 which is under control of the HCU/MCU 160.

The electric vehicle 100 according to an embodiment as described above may be configured with various sensors and processing devices for collecting data requested or generated in driving the electric vehicle.

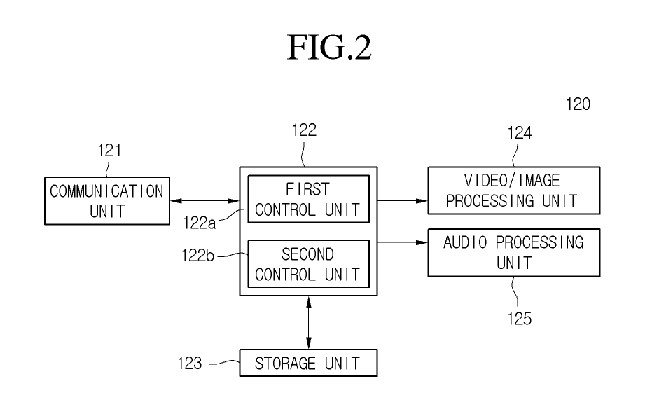

Hereinafter, description about a configuration of the ECU 120 according to an embodiment is made in detail with reference to FIG. 2.

FIG. 2 is a block configuration diagram of the ECU according to an embodiment.

Referring to FIG. 2, the ECU 120 according to an embodiment may include a communication unit 121, a control unit 122, a storage unit 123, an image processing unit 124, and an audio processing unit 125.

The communication unit 121 may collect data generated and output from various sensors and a configuration unit configuring the vehicle 100, and transmit control data corresponding to the collected data.

The control unit 122 may process and operate data generated and output from the various sensors and configuring unit configuring the vehicle 100. In addition, the control unit 122 may generate control data on the basis of the operated and processed data.

The control unit 122 may be configured with a first control unit 122a and a second control unit 122b according to an embodiment.

The first and second control units 122a and 122b may operate and process data requested for driving the vehicle 100 and generated at the time of the driving.

The first and second control units 122a and 122b may process different data according to processing target data and a data size of the processing target data. For example, the first control unit 122a may process data except image/video data among data requested for driving the vehicle 100 and generated at the time of the driving. Alternatively, the first control unit 122a may limit and process data, the size of which is smaller than a reference size among the data. In addition, the first control unit 122a may classify data to be processed by the first and second control units 122a and 122b, and generate processing control signals (processing instruction signals) according to the classified data.

The second control unit 122b may operate and process data instructed on the basis of a control by the first control unit 122a. Furthermore, the second control unit 122b may limit and process the image/video data among data requested for driving the vehicle 100 and generated at the time of the driving. In other words, the second control unit 122b may perform a limited operation and process on preset processing target data. Furthermore, the second control unit 122b may operate and process data having at least preset reference size on the basis of a data processing size confirmed by the first control unit 122a.

The numbers of cores mounted on the first and second control units 122a and 122b may be different. In other words, any one of the first and second control units 122a and 122b is better than the other in processing size and speed due to difference in processing target data thereof. In an embodiment, a case is exemplarily described where the second control unit 122b has more cores than the first control unit 122a. In other words, the first control unit 122a may be a general CPU and the second control unit 122b may be a large size data processing control unit such as a graphics processing unit (GPU). The first and second control units are not limited in performances and the numbers of the cores, and the number of the control units may be also variable. Furthermore, functional characteristics of the first and second control units may be mutually changed.

The storage unit 123 may store a program for operating the control unit 122 and temporarily store input/output data. The storage unit 123 according to an embodiment may store information on processed data and processing results thereof. Furthermore, the storage unit 123 may store information on a kind of data and a reference size of data in order to determine a control unit for the processing target data.

The image processing unit 124 may process to output a video/image through an output device (e.g., a monitor etc.) of the vehicle 100 on the basis of an output result processed by and output from the control unit 122.

The audio processing unit 125 may process to output an audio through an output device (e.g., a speaker etc.) of the vehicle 100 on the basis of an output result processed by and output from the control unit 122.

As described above, the ECU 120 of the electric vehicle according to an embodiment may be configured with the plurality of data processing control units 122a and 122b and each of the plurality of the control units 122a and 122b may process data according to a kind or a size of the data.

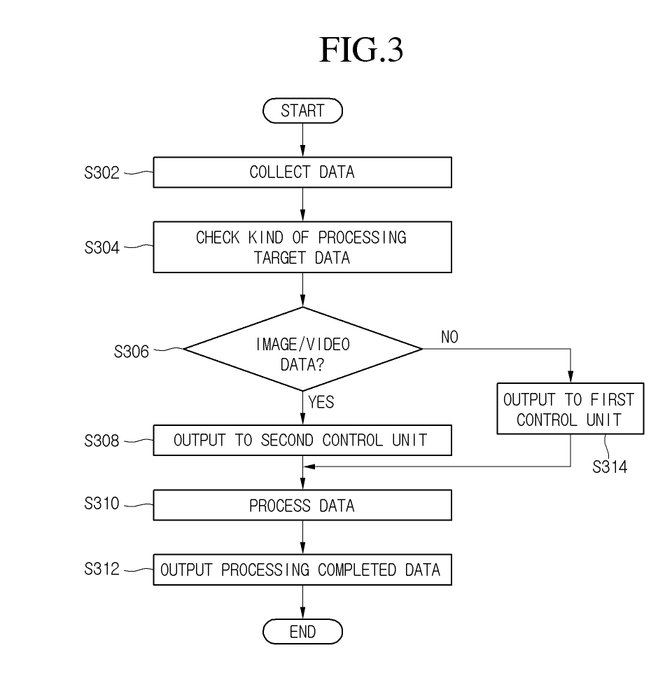

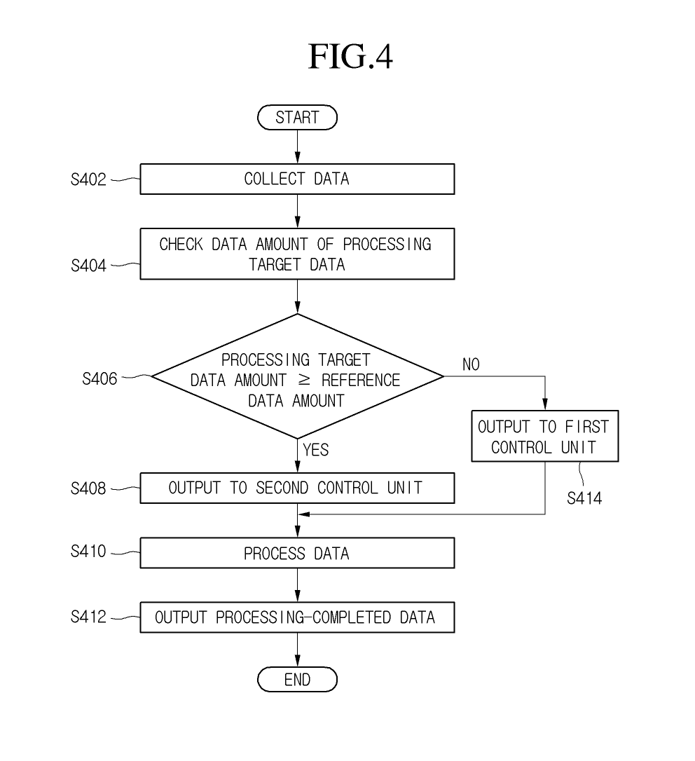

Hereinafter, a data processing method according to an embodiment is described in detail with reference to FIGS. 3 and 4.

FIG. 3 is a flowchart of a data processing operation according to an embodiment.

Referring to FIG. 3, the communication unit 121 of the ECU 120 may collect driving data for the vehicle 100 or data required to drive the vehicle 100 (operation S302).

The control unit 122 may check the kind of the collected data (operation S304). At this point, the checking operation of the kind of the collected data may be performed by the first control unit 122a. However, the embodiment is not limited hereto. When a plurality of control units are prepared, any one control unit may check the kind of data and the control unit checking the kind of data may be a control unit except for one having the best performance or a control unit having the lowest performance.

In the embodiment, it is assumed that the first control unit 122a is a main control unit and at least one control unit connectable to the main control unit 122a is defined as the second control unit 122b.

The first control unit 122a may check whether there is the image or video data among the checked data on the basis of the checked result of the kind of the collected data (operation S306).

When there is the image or video data, the first control unit 122a may output a control signal for processing the image or video data (operation S308), and the second control unit 122b may process the data.

The image or video data processed by the second control unit 122b may be image or video data required for an operation of the vehicle 100 or image or video data received from the inside or outside of the vehicle 100. The second control unit 122b may control an operation or output for checking and processing the image or video data.

The second control unit 122b may output an operation and process control signal to the image processing unit 124 and output the process-completed data by the image processing unit 124 on the basis of the control signal to the output device (operation S312).

On the contrary, when there is not the image or video data according to the checked result of the kind of the collected data, the processing control signal for the collected data may be generated and output by the first control unit 122a (operation S314).

FIG. 4 is a flowchart of a data processing operation according to another embodiment.

Referring to FIG. 4, the communication unit 121 of the ECU 120 according to an embodiment may collect driving data for the vehicle 100 or data required to drive the vehicle 100 (operation S402).

The control unit 122 may check the kind of the collected data (operation S404). At this point, the checking operation of the kind of the collected data may be performed by the first control unit 122a.

In another embodiment, it is assumed that the first control unit 122a is a main control unit and at least one control unit connectable to the main control unit 122a is defined as the second control unit 122b.

The first control unit 122a may check whether there is data having at least a reference data size among the classified data on the basis of the checked result of the size of the collected data (operation S406).

When there is the data having the reference size or greater, the first control unit 122a may output a control signal for processing the data having the reference size or greater (operation S408), and the second control unit 122b may process the data (operation S410).

The data having the reference size or greater and processed by the second control unit 122b may be data required for operating the vehicle 100 or data received from the inside or outside of the vehicle 100. The second control unit 122b may check the data having the reference size or greater among the data and control an operation and output for processing.

On the contrary, when there is not the data having the reference size or greater according to the checked result of the size of the collected data, the processing control signal for the collected data may be generated and output by the first control unit 122a (operation S414).

In the other embodiment, it is assumed that the second control unit 122b is one. However, a sub-control unit such as the second control unit 122b may be configured in the plurality, and the data to be processed by the sub-control unit may be distributed over a plurality of sub-control units and processed.

Furthermore, in the embodiment and the other embodiment, data is described as being classified and processed by the first and second control units according to kind and size of the data. Besides, data to be processed by the first and second control units may be classified by firstly classifying a kind of data and checking a size of the classified data. In other words, the data to be processed by the first and second control units among the collected data and the data having the reference size or greater is processed by the second control unit according to the data size of the classified data. Furthermore, data having a smaller size than the reference size is allowed to be processed by the first control unit, even though the data has the kind to be processed by the second control unit. Accordingly, loads are not condensed in each control unit and may be uniformly divided.

According to the data processing device and method for a vehicle including a plurality of electronic components of high performance, a data processing and operation speed can be increased and accordingly an accurate output value thereof can be output.

In addition, according to the data processing device and method for a vehicle, a large amount of data cab be processed by a plurality of operation and processing devices and accordingly an overload on a control device can be prevented.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An electric vehicle comprising:
an engine;
a motor connected to the engine and generating a driving torque; and
an electronic control unit (ECU) controlling an operation of the engine, detecting a driving request signal, and including a plurality of controller for processing data generated on the basis of the driving request signal,
wherein the ECU allows each of the plurality of control units to process the data on the basis of information on the data.

2. The electric vehicle according to claim 1, wherein the ECU checks data required for driving the vehicle or information on data generated at the time of driving the vehicle, and allows the plurality of control units to process the data on the basis of the checked information.

3. The electric vehicle according to claim 1, wherein the ECU classifies data according to a kind thereof on the basis of the checked data information and allows the plurality of control units to process the classified data.

4. The electric vehicle according to claim 3, wherein the ECU comprises,
a first control unit; and
a second control unit,
wherein image or video data among the kind of classified data is processed by the second control unit, and other data is processed by the first control unit.

5. The electric vehicle according to claim 4, wherein the data classification is performed by the first control unit.

6. The electric vehicle according to claim 4, wherein the numbers of cores of the first and second control units are different and accordingly performances thereof are different.

7. The electric vehicle according to claim 6, wherein the second control unit has higher performance in processing capability than the first control unit.

8. The electric vehicle according to claim 2, the ECU classifies data according to a size of the data on the basis of the checked data information and controls so that each of the plurality of control units processes the classified data.

9. The electric vehicle according to claim 8, wherein the ECU comprises,
a first control unit; and
a second control unit,
wherein data having a reference size or greater among the classified data is processed by the second control unit, and other data is processed by the first control unit.

10. The electric vehicle according to claim 9, wherein the data classification is performed by the first control unit.

11. The electric vehicle according to claim 1, wherein the ECU comprises one main control unit and a plurality of sub-control units.

12. The electric vehicle according to claim 11, wherein each of the plurality of sub-control units classifies and processes data according to a priority, a processing order, or an amount of data to be processed.

13. The electric vehicle according to claim 1, wherein the ECU comprises a plurality of control units having the different numbers of cores.

14. The electric vehicle according to claim 13, wherein the ECU comprises one main control unit and a sub-control unit having at least one other control unit on the basis of the number of cores and performance among the control units having the different number of cores.
